(19) United States
(12) Patent Application Publication
(10) Pub. No.: US 2016/0147246 A1
(43) Pub. Date: May 26, 2016

(54) Fast Bias Current Startup with Feedback

(71) Applicant: Dialog Semiconductor (UK) Limited, Reading (GB)

(72) Inventor: Jindrich Svorc, Swindon (GB)

(21) Appl. No.: 14/550,925

(22) Filed: Nov. 22, 2014

(30) Foreign Application Priority Data
Nov. 20, 2014 (EP) 14194212

(51) Int. Cl. G05F 3/26

(52) U.S. Cl. CPC G05F 3/26

(57) ABSTRACT

A current mirror circuit comprising an input driver connected to a plurality of output driver circuits through a current mirror network. The current mirror network is separated into two parts, wherein the first part comprises the input driver circuit and the second part comprises capacitive loads including a filter capacitor. A switch separates the two parts where an amplifier senses the first part and controls the second part to track the first part when the current mirror circuit is activated. The low source resistance of the output of the amplifier facilitates a fast charging of the capacitance of the second part of the current mirror network dramatically improving signal delay and transition time.

### RELATED PATENT APPLICATION

This application is related to U.S. patent application docket number DS13-081, Ser. No. 14/550,924, filed on Nov. 22, 2014, and assigned to the same assignee as the present invention, and which is herein incorporated by reference in its entirety.

### 1. TECHNICAL FIELD

The present disclosure is directed to a fast start-up circuit, in particular for a low power current mirror.

### 2. BACKGROUND

In general every analog block within an integrated circuit needs a current bias to allow for proper operation. A main current bias distribution within a chip can be a current source that is distributed with in an integrated circuit chip by means of a few current mirror circuits. The bias current circuit causes additional power consumption.

Because the bias current circuit is additional power consumption for the chip, the actual used value is small, especially in very low power design, which can be down to a few tenths of a nano-amp. Such a small current is prone to being disturbed by other circuitry on the chip and sometimes by the biased block itself. In order to filter such a noise disturbance, a simple low pass filter usually created by a normal capacitor or MOS capacitor is added.

US 2013/0033104 A1 (Gunther et al.) is directed to a system that includes a start-up circuit that compares a feedback voltage to an output voltage. US 2011/0274290 A1 (Holzmann et al.) is directed to a driver device with a bias circuit that includes a buffer for rapidly charging an external capacitance. US 2005/0134344 A1 (Ro) is directed to a method and a system to provide a fast start-up circuit for a pre-scaler device. US 2004/0113706 A1 (Yen et al.) is directed to a fast start-up oscillator, which provide a fast stabilized voltage source. U.S. Pat. No. 8,283,974 B2 (Chu et al.) is directed to a fast start-up low voltage bandgap reference voltage generator.

In FIG. 1 is shown a bias circuit of prior art, wherein a main current bias, Ibias, is distributed by means of current mirrors like N1 and Nx. Since the bias current is additional power consumption, the actual amount used is reasonably small, especially in very low power design that can be down to few tenths of nano-amps. These small current amounts are prone to be disturbed by other circuitry on the chip, which can be sometimes disturbed by the biased block itself. A simple low pass filter, usually created by a normal capacitor or MOS capacitor is added to filter noise and disturbance from other circuitry. This capacitor might be also created by the input gate capacitance of all the mirror transistors which are connected to the nbias node so it disappears from the schematic, but it is still present. It is depicted in FIG. 1 as C1. This low pass filter filters the nbias node voltage and makes the currents Ibias_2 and. Ibias _x less noisy.

Using capacitance C1 to filter noise has a drawback, which is long start-up time of the circuit. When the block is disabled, the disable switch S2 is ON and enable switch S1 is OFF. This means the nbias voltage is 0V, and voltage at nswitch is equal to Vdd. When the current bias is enabled, the disable switch S2 is turned OFF and enable switch S1 is turned ON. Bias current starts flowing from drain of P2, which starts the charging of C1. At that moment no current is flowing through Ibias_2 through Ibias_x branches. The voltage in nbias is increasing as C1 is being charged and finally at the moment when the nbias reaches threshold voltage of the transistor Nx, the current in the branches ‘Ibias_x’ starts flowing. It takes even a longer time until the current in the Ibias_x branch is fully settled.

FIG. 2 shows waveforms at key locations in the circuit of FIG. 1. As switch S1 is closed, switch S2 is opened, causing voltage at node nswitch to fall to ground before recovering to nbias that is between Vdd and 0V. The current Ibias 2 is somewhat delayed beyond the start of nbias until the gate of the N2 transistor is brought up to a threshold voltage.

### SUMMARY

It is an objective of the present disclosure to speedup current bias for analog blocks within an integrated circuit.

It is also and objective of the present disclosure to speedup the signal transition times of the current signals.

It is further an objective of the present disclosure to charge current mirror capacitance with a low impedance source to improve circuit rise time within the current mirror circuit.

The current mirror circuit of the prior art comprises an input driver, designated as N1, and a plurality of output driver transistors designated as N2 to Nx in FIG. 1. The current mirror network designated as nbias distributes gate bias in the current mirror circuit to the output driver transistors in a low current environment, wherein the output driver transistors in FIG. 1 supplies current to a logic block of circuits that is slow as a result of circuit capacitance, which includes gate capacitance, filter capacitance and parasitic capacitance, and which is charged with a relatively low current source having a relatively high source impedance. This results in a long transition time and adds significantly to a slow startup current startup.

A first embodiment of the present disclosure dramatically improves the signal delay of the circuitry shown in FIG. 1 of the prior art. This is accomplished by separating the nbias network of the current mirror circuit into two parts, wherein the first part of the nbias network contains only the input driver of the current mirror circuit, and the second part contains the input gates of the plurality of output drivers including the filter capacitor. An amplifier is used to monitor the first part of the nbias network and control the second part of the nbias network to track the first part as the current mirror circuit is powered on. The low impedance of the output of the amplifier allows the second part of the current mirror circuit to charge quickly matching the turn on of the first part of the current mirror circuit. A comparator circuit compares a reference current with an output current of the current mirror circuit and when the comparator circuit is tripped, an RS flip flop is set, which disconnects the amplifier and reconnects the first and second parts of the current mirror. The reconnection of the two parts of the current mirror circuit is a smooth operation since the amplifier had been controlling the second part of the current to track the first part of the current mirror circuit.

In a second embodiment two NMOS transistors comprise the amplifier of the first embodiment and the RS flip flop which is created by a switch and the current comparator. The switch is driven by the output of the comparator circuit. When the output current reaches a threshold current, the switch that forms part of the RS flip flop with the current comparator turns off the switch, which latches the output of the comparator because the input to the comparator is held down by a transistor in the current mirror circuit. At the same time the amplifier is disabled and the two parts of the current mirror circuit are rejoined.

### BRIEF DESCRIPTION OF THE DRAWINGS

This invention will be described with reference to the accompanying drawings, wherein:

FIG. 1 is a circuit diagram of a current mirror circuit of prior art;

FIG. 2 is a set of waveforms associated with the prior art current mirror circuit of FIG. 1;

FIG. 3 is a current mirror circuit of the first embodiment of the present disclosure;

FIG. 4 is a current mirror circuit of the second embodiment of the present disclosure; and

FIG. 5 is diagram of the performance improvement of the present disclosure.

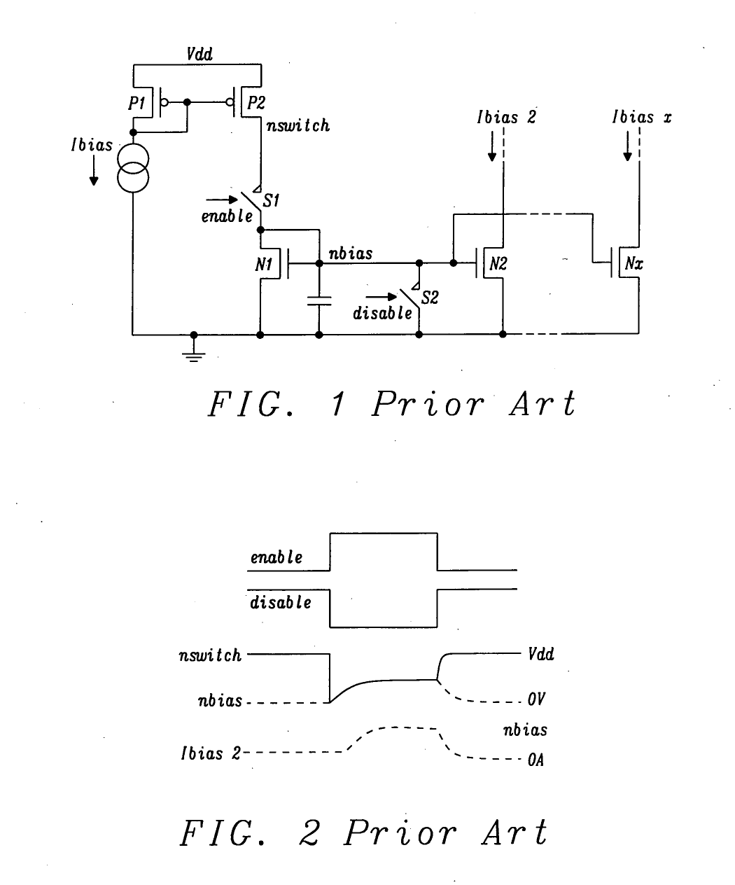

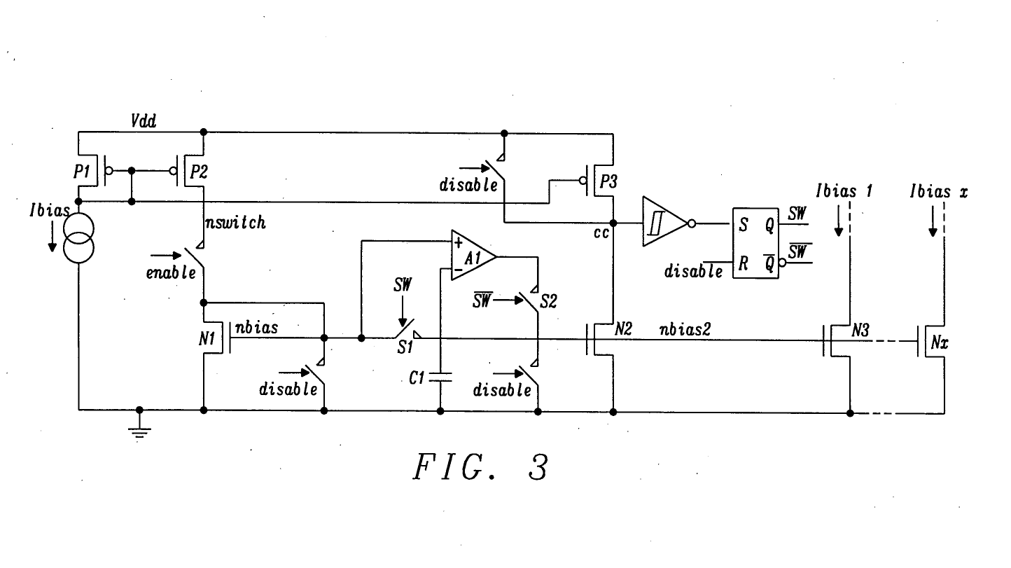

### DETAILED DESCRIPTION

In FIG. 3 is shown a schematic of the first embodiment of the present disclosure. A source current mirror circuit comprising transistors P1, P2 and P3 distributes Ibias to the main current mirror circuit comprising N1, N2 and N3 to Nx, wherein N3 to Nx are current mirror driver circuits to provide load current, Ibias_1 to Ibias_X, to circuits on an integrated circuit device, and wherein N2 is a driver circuit that provides current to a comparator circuit. The comparator circuit drives an RS flip-flop to control switches S1 and S2, Switch S1 separates the current mirror network into two parts nbias and nbias2 and switch S2 connects the output of the amplifier A1 to nbias2. The positive input to the amplifier A1 is connected to nbias and the negative input to the amplifier is connected to nbias2. This allows amplifier A1 to track the voltage of the first part of the current mirror network, nbias, and control the second part of the current mirror circuit, nbias2, to follow the first part by driving the capacitance of the second part with the low output resistance of amplifier A1. Therefore, the first part of the current mirror network charges relatively quickly because there is very little capacitance to charge. At the same time the second part of the current mirror network, nbias2, closely tracks the first part because the capacitance of the second part of the current mirror network (C1 and the parasitic capacitance of drivers N2, and N3 through Nx) is being charged by a low impedance output of the amplifier A1.

As the capacitance connected to the second part of the current mirror network is charged by amplifier A1, transistor N2 provide a current to the comparator circuit CC and compared to current from transistor P3 that is part of a bias current mirror circuit. When the current level from N2, which is equal to current from P3, which is equal to Ibias, the comparator triggers the RS flip-flop to close Switch S1 and open switch S2. Thus the current mirror quickly comes to full scale operation because the amplifier controlled the second part of the current mirror network nbias2 to follow the voltage of the first part nbias and the output of the amplifier A1 charged the capacitance of the second part with a low impedance output.

The current mirror circuit shown in FIG. 1 produces huge delay when the block is enabled since the input bias current needs to charge the parasitic capacitance of the input transistor, the base of all the transistors in the current mirror and the filtering capacitance tied to the gate node. The proposed solution acts differently in the enabling stage. In this stage the switch S1 is open and input transistor is not connected to the rest of the current mirror. It means the bias current is charging the parasitic capacitance of the input transistor only. The amplifier keeps the gate voltage of the rest of the current mirror at the same potential as the input transistor but since the output impedance of the amplifier is much lower than the output impedance of the current bias the net nbias2 follows net nbias.

Combination of two transistors P3 and N2 create current comparator which compares the reference current derived from the Ibias via P3 with the output current from N2. At the moment when the comparator trips the RS flip-flop is set and switches S1 and S2 controlled from the output of the RS flip-flop to disconnect the output of the amplifier and short the nets nbias and nbias2 together. In the other words the amplifier is charging net nbias2 to the correct potential and then re-connects the nbias2 network to the nbias network and the circuit works as simple current mirror.

It should be noted that in FIG. 3 that there are a number of switches denoted with either ‘enable’ or ‘disable’. The switches do not affect on the operation of the circuitry as noted above as long their open/closed status is not changed from that shown in FIG. 3. The purpose of these switches is to disable, or enable, the current mirror circuitry.

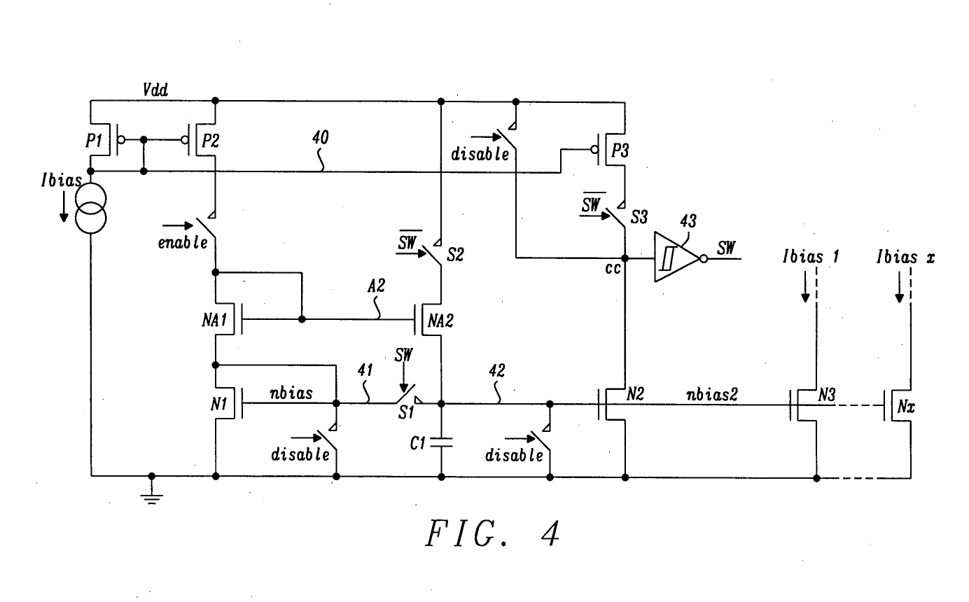

In FIG. 4 is shown a second embodiment of the present disclosure. The circuitry of the second embodiment is basically the same as shown in FIG. 3 with the exception of the detail implementation of the amplifier A2 and the comparator circuitry 43. The amplifier A2 comprises transistors NA1 and NA2, wherein transistor NA1 is connected to a current source network output transistor P2, wherein transistor P2 forms a part of a current mirror circuit 40 that provides input source current to the main current mirror circuit comprising N1 and network parts nbias 41 and nbias2 42. The amplifier A2 is connected to the first part of the main current mirror network nbias through a connection to P2, and the output of the amplifier is connected to the second part of the current mirror network nbias2, wherein the source of transistor NA2 connects to nbias2 providing a low output source impedance. Switch S2 when opened disconnects the amplifier A2 from providing any further energy to operating the fast start up circuit.

When the circuit of FIG. 4 is first started up, switch S1 is opened forming a first part of the current mirror circuit comprising N1 connected to nbias and a second part comprising nbias2 to which is connected the gate capacitance of a plurality of transistor gates and a filter capacitor C1. Thus the second part of the current mirror network is separated into low capacitance (part 1) and high capacitance (part 2). The low source impedance of the output transistor NA2 of amplifier A2 is used to drive the high capacitance of the second part of the current mirror network nbias2. Thus the amplifier A2 detects the bring-up voltage of the first part of the current mirror network and controls the second part of the current mirror network to quickly follow the bring-up voltage of the first part, and when the two parts are brought back together there will not be any affects from the voltage on nbias and nbias2 since they are the same.

Transistor N2 provides a current from the second part of the current mirror network as the amplifier A2 powers up the second part of the network, and P3 provides a target current from the current mirror source comprising P1, P2 and P3. When the current from N2 equals the current from P3 at the input node cc of the current comparator, control signal SW turns off switch S3 which latches the output of the comparator since the input node CC of the comparator is held down by transistor N2. At the same time the amplifier is disabled by the opening of S2 and S1 is closed to reconnect nbias to nbias2.

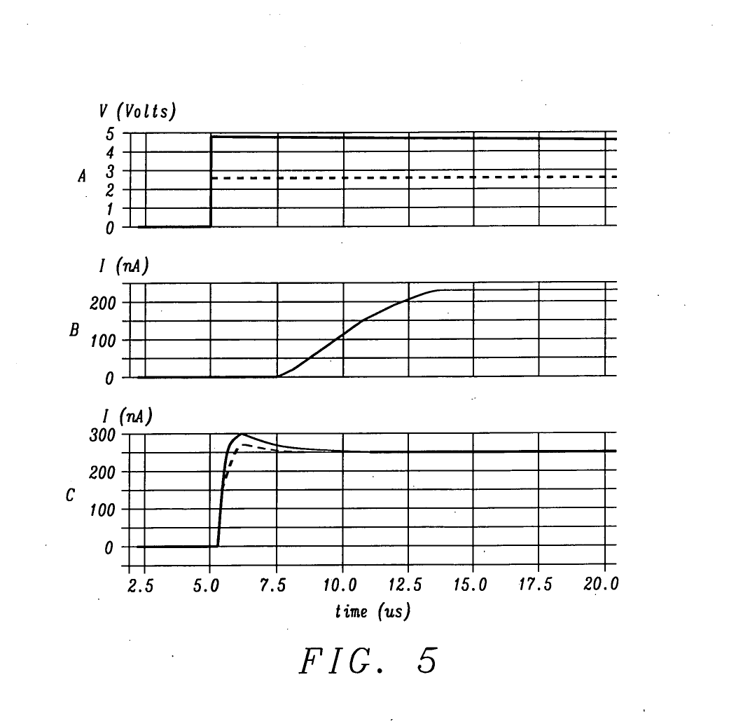

FIG. 5 demonstrates the performance improvement caused by the circuit improvements of FIG. 3 and FIG. 4. FIG. 5A shows the input voltage where the solid and dashed line are two different voltage levels. FIG. 5B shows the response of the current mirror to a step function, and FIG. 5C the response of the circuit of FIG. 3 and FIG. 4 to the step function FIG. 5A. It is clearly seen that both delay and rise time are dramatically improved.

It should be noted that although the shown solution comprises a NMOS current mirror, similar performance improvement can be accomplished for a PMOS current mirror.

While the invention has been particularly shown and described with reference to preferred embodiments thereof, it will be understood by those skilled in the art that various changes in form and details may be made without departing from the spirit and scope of the invention.

What is claimed is:

1. A fast start-up power circuit, comprising:
a) a current mirror circuit;
b) a current mirror network connecting an input driver circuit to a plurality of output driver circuits, wherein one output driver circuit used to provide drive current for comparison to source current;
b) an amplifier comprising low output resistance;
c) said current mirror network separated into two parts, wherein a first part comprises said input driver circuit and a second part comprises a capacitive load; and
d) said amplifier inserted into the separation between the first and second parts. of said current mirror network to drive said capacitance load of the second part with said low output resistance of the amplifier, wherein the second part of the current mirror network tracks the first part, and results in improved start-up time.

2. The power circuit of claim 1, wherein the high capacitance is formed in part by a filter capacitor.

3. The power circuit of claim 2, wherein the filter capacitor is a low pass filter formed from a MOS capacitor.

4. The power circuit of claim 1, wherein said amplifier controls a voltage of the second part to be same as the voltage of the first part.

5. The power circuit of claim 1, wherein said current mirror network separated into two parts by a switch controlled by an output of an RS flip-flop circuit.

6. The power circuit of claim 5, wherein said RS flip-flop circuit is eliminated in favor of a current comparator circuit.

7. The power circuit of claim 5, wherein said switches comprising a first switch that disconnects said first part of the current mirror network from said second part of the current mirror network and a second switch, which connects amplifier output to the second part of the current mirror network, wherein a first amplifier input connected to the first part of the current mirror network and a second amplifier input connected to the second part of the current mirror network.

8. The power circuit of claim 5, wherein said amplifier controls the voltage on the second part of the current mirror network to track a voltage of the first part while the first and second parts of the current mirror network are separated, and wherein the first part and the second part of the current mirror network are reconnected without any noticeable voltage difference.

9. The power circuit of claim 1, wherein said amplifier is connected between an input to the current mirror circuit and the second part of the current mirror network.

10. A method of speeding-up a bias circuit, comprising:
a) forming a current mirror circuit with a current mirror network connecting an input circuit with a plurality of output driver circuits;
b) separating the current mirror network into two parts with a switch, wherein a first part comprises the input circuit and a second part comprises output driver circuits;
c) connecting a first input of an amplifier to the first part of the current mirror network, a second input of the amplifier to the second part of the current mirror network, and an output of the amplifier to the second part of the current mirror network; and
d) opening said switch to separate the current mirror network into two parts, wherein the first part and the second part of the current mirror network is sensed by two amplifier inputs, and the output of the amplifier drives the second part of the current mirror network to track the voltage of the first part while charging the capacitance of the second part of the current mirror network with a low impedance amplifier output circuit, and wherein one output driver circuit used to track output driver current of the second part of the current mirror network.

11. The method of claim 10, wherein said amplifier has a low output resistance to drive the capacitive load of the second part of the current mirror network.

12. The method of claim 10, wherein said capacitive load of the second part of the current mirror network comprises a filter capacitor and parasitic capacitance of the gates of the current mirror driver circuits.

13. The method of claim 10, wherein said switch is closed when a target current is reached in the comparator circuit, thereby connecting the first and second parts of the current mirror network back together.

14. The method of claim 13, wherein the target current is reached in the comparator circuit, the amplifier is disconnected from the current mirror circuit.

15. The method of claim 13, wherein said target current is driver current of said current source.

16. The method of claim 13, wherein the comparator circuit compares current from an output driver circuit of the second part of the current mirror network to a current from a driver circuit of a current source to determine when the second part of the current mirror network is at operating level.

17. The method of claim 15, wherein operating level is determined when current through the output driver circuit connected to the current mirror network is a same amplitude as the current from said driver circuit of the current source

18. The method of claim 15, wherein an RS flip-flop is driven by the comparator to disconnect the amplifier output from the second part of the current mirror network and rejoin the first and second parts of the current mirror network.

19. The method of claim 15, wherein the RS flip-flop is created between the comparator circuit and a switch connecting the comparator circuit to the driver circuit of the current source.
